(19) United States
(12) Patent Application Publication
(10) Pub. No.: US 2017/0030277 A1
(43) Pub. Date: Feb. 2, 2017

(54) METHOD FOR PROCESSING SENSOR SIGNALS

(71) Applicant: Robert Bosch GmbH, Stuttgart (DE)

(72) Inventors: Thomas Bleile, Stuttgart-Zuffenhausen (DE); Slobodanka Lux, Deizisau (DE); Wilhelm Blumendeller, Freiberg (DE); Martin Hoerner, Stuttgart (DE); Nico Schick, Leutenbach (DE)

(21) Appl. No.: 15/221,240

(22) Filed: Jul. 27, 2016

(30) Foreign Application Priority Data
Jul. 29, 2015 (DE) 102015214363.5

(51) Int. Cl. F02D 41/00; F02M 26/52; F02M 26/45

(52) U.S. Cl. CPC F02D 41/0047; F02M 26/45; F02M 26/52; F02M 2026/005

(57) ABSTRACT

A method for processing sensor signals in a control unit of a motor vehicle and a control unit for carrying out the method. The control unit is provided for the open-loop and/or closed-loop control of a system and acquires signals from this system. The system is modeled with the aid of a model, at least one value being ascertained for a slow signal based on the model.

### CROSS REFERENCE

The present application claims the benefit under 35 U.S.C. §119 of German Patent Application No. DE 102015214363.5 filed on Jul. 29, 2015, which is expressly incorporated herein by reference in its entirety.

### FIELD

The present invention relates to a method for processing sensor signals in a control unit of a motor vehicle and a control unit for carrying out the method.

### BACKGROUND INFORMATION

Control units are electronic components that are used in motor vehicles for the open-loop and closed-loop control of sequences and components. Thus, for example, the engine control unit is responsible for the operation of the combustion engine used in the motor vehicle. To that end, information is read in by the control unit via signals, and after their processing, control signals are output.

Modern electronic engine managements for piston engines as a type of an internal combustion engine have a high-pressure exhaust gas recirculation for optimal open-loop and closed-loop control of the intake air and inert gases. To optimize emissions, in addition, a low-pressure exhaust gas circulation system may be included. Therefore, a low-pressure exhaust gas recirculation system and a high-pressure exhaust gas recirculation system are provided.

Exhaust gas recirculation (EGR) in combustion engines, which are used in motor vehicles, for instance, denotes a process employed to reduce pollutant emissions. Using this process, a portion of the exhaust gases is returned to the intake manifold of the combustion engine, and in this manner, the highest combustion temperature is decreased and especially in the case of diesel engines, the amount of nitrogen oxides is reduced. In the case of gasoline engines, the exhaust gas recirculation is used primarily to reduce fuel consumption.

The quantity of exhaust gases returned and the amount of fresh air flowing in, and thus the combination of fresh air and exhaust gas during the combustion in the cylinder are adjusted as part of an exhaust gas recirculation control. The fresh-air mass is denoted as controlled variable for which, in addition, the appropriate portion of exhaust gas is determined within the regulating device. Depending on the design, control elements for regulating the air mass may be a throttle valve, a high-pressure (HP) EGR valve, a low-pressure (LP) EGR valve in combination with an exhaust-gas flap or a low-pressure (LP) fresh-air restrictor or a LP three-way valve.

It should be noted that because of different measuring techniques of sensors for various physical signals in the air system, the measured signals have a different phase position. In addition, different signal filterings are used for different signals. That is because, in part, higher frequencies are to be filtered out.

Due to the opening and closing of the intake/exhaust valves, also referred to as gas-exchange valves, a pulsating air column develops in the air system. For example, these pulsations are apparent in the physical pressure values, air-mass flow values and lambda-probe values. However, many control-unit air-system models are based on the assumption that averaged sensor values, in which pulsations are filtered out, are present. Due to this filtering, however, a phase lag develops in the signals. These signals are referred to hereinafter as slow signals.

For example, fast signals are controller signals, e.g., controller-activation and controller-positioning signals, which only have to be conditioned to a small extent.

If calculations are now carried out with the slow signals and fast signals, unphysical overshoots are obtained. These overshoots may lead to an unstable behavior of the cylinder-charge control.

Conventionally, the faster sensor signals dynamically adapt to the slower sensor signals in the control unit in order to obtain signals consistent with one another and therefore to avoid unphysical overshoots. However, due to the lag of the slower sensor signals, all in all, the cylinder-charge control becomes slower.

### SUMMARY

With a method in accordance with the present invention, it is possible in embodiment to dynamically adapt slow control-unit signals, e.g., of the air system, to the fast control-unit signals using an observer structure.

For example, slow signals relate to signals that carry information concerning the air-mass flow or the pressure, e.g., the signal of the fresh-air-mass meter or the λ-probe. They are signals which, because of pulsations, must be post-processed, thereby resulting in phase shifts. These pulsations are apparent in the physical pressure values and air-mass-flow values.

For example, fast signals are controller signals, e.g., controller-activation and controller-positioning signals, which only have to be conditioned to a small extent.

For instance, the method lends itself for when the signal of the fresh-air-mass meter is used as slow signal and a controller signal is used as fast signal. In the case of both of these, if they are not processed according to the method presented, a great phase lag comes about and consequently great overshoots or undershoots upon offsetting of the two signals. The slow signal may be a signal with regard to a pressure-sensor value and/or mass-flow value.

In embodiment, according to the present invention, the at least one slow sensor signal is modeled based on the dynamically faster sensor signals and input quantities into the system, e.g., the air system, and in one implementation, the model is corrected based on the difference between the measured slow and the modeled sensor value, the observational error. This is referred to as adaptation of the model. Thus, at least one value is ascertained for the at least one slow sensor signal. Usually a time characteristic of the at least one slow sensor signal, i.e., a sequence of values, is ascertained.

For example, a system model of the system overall engine or of the system exhaust gas recirculation is used as model. In so doing, among other things, volume effects and running-time effects are taken into account. It is important that the model is able to be adapted, that is, that quantities ascertained by the model are compared to actual or measured quantities, and on this basis, the model is adjusted or adapted at regular intervals or even continuously. It is noteworthy that a subsystem, that is, a part of an overall system may also be modeled using the model.

It presents itself to use a physical model as model, in which the physical sequences are taken into consideration in the modeled system. Alternatively, a mathematical model or a combined model may also be employed.

By using the method introduced, consistent, fast input signals are available from the phase and the control parameters for the cylinder-charge control may thereby be construed more rapidly. In this way, emissions may be reduced.

Further advantages and refinements of the present invention are derived from the description and the accompanying drawing.

It shall be understood that the aforementioned features and the features yet to be explained below may be used not only in the combination indicated in each instance, but also in other combinations or by themselves, without departing from the scope of the present invention.

### BRIEF DESCRIPTION OF THE DRAWINGS

FIG. 1 shows a schematic representation of a combustion engine with exhaust gas recirculation.

FIG. 2 shows graphs of signal characteristics for the purpose of illustrating the method presented.

### DETAILED DESCRIPTION OF EXAMPLE EMBODIMENTS

The present invention is represented schematically in the drawing in light of specific embodiments, and is described in detail below with reference to the drawing.

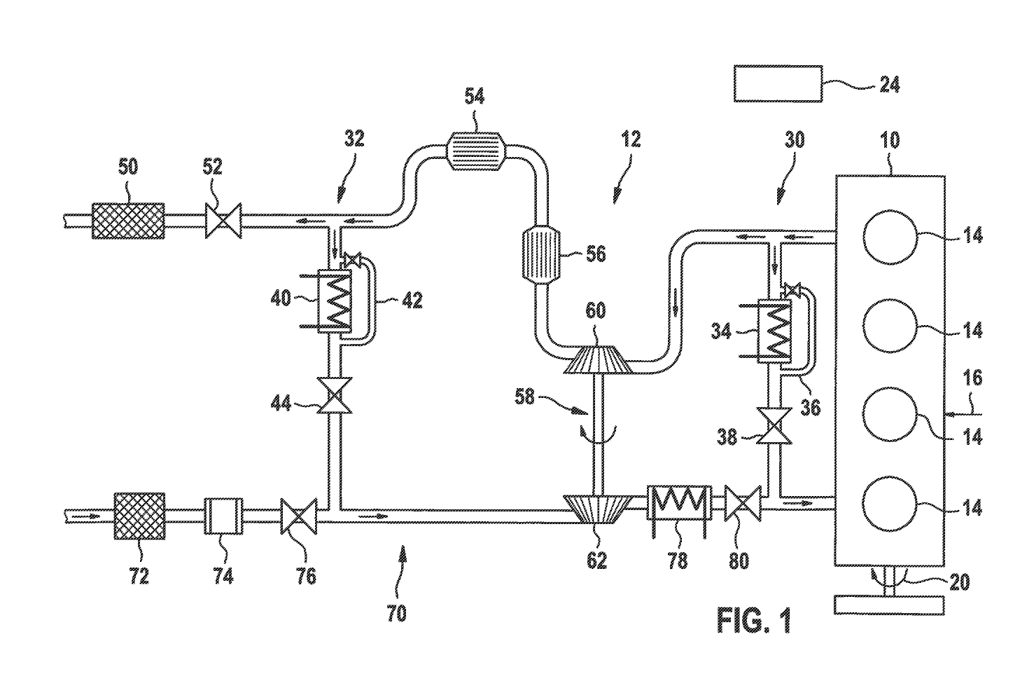

FIG. 1 shows a schematic representation of a combustion engine 10, that has an exhaust gas recirculation 12. Combustion engine 10, which in this case is in the form of a diesel engine, has four cylinders 14, receives a torque demand m_{F} 16 from the driver by operation of the accelerator pedal and supplies a speed n 20. A control unit 24 is provided to control combustion engine 10 and exhaust gas recirculation 12.

In this design, exhaust gas recirculation 12 includes a high-pressure exhaust gas recirculation 30 (HP-EGR) and a low-pressure exhaust gas recirculation 32 (LP-EGR). In high-pressure exhaust gas recirculation 30, a HP cooler 34 with bypass 36 and a HP-EGR valve 38 are provided. Low-pressure exhaust gas recirculation 32 includes a LP cooler 40 with bypass 42 and a LP-EGR valve 44. In addition, the figure shows a muffler 50, an exhaust-gas flap 52, a diesel-particle filter 54, a catalytic converter 56 as well as a turbocharger 58 having a turbine 60 and a compressor 62. Moreover, the figure shows a fresh-air feed 70 having an air filter 72, a fresh-air-mass meter 74, a fresh-air restrictor 76, a charge-air cooler 78 and a throttle valve 80.

HP-EGR valve 38, LP-EGR valve 44, exhaust-gas flap 52 or fresh-air restrictor 76 and throttle valve 80 are the control elements of exhaust gas recirculation 12 for the air-mass control.

It should be noted that in the practical application, typically either a fresh-air restrictor 76 or an exhaust-gas flap 52 is used.

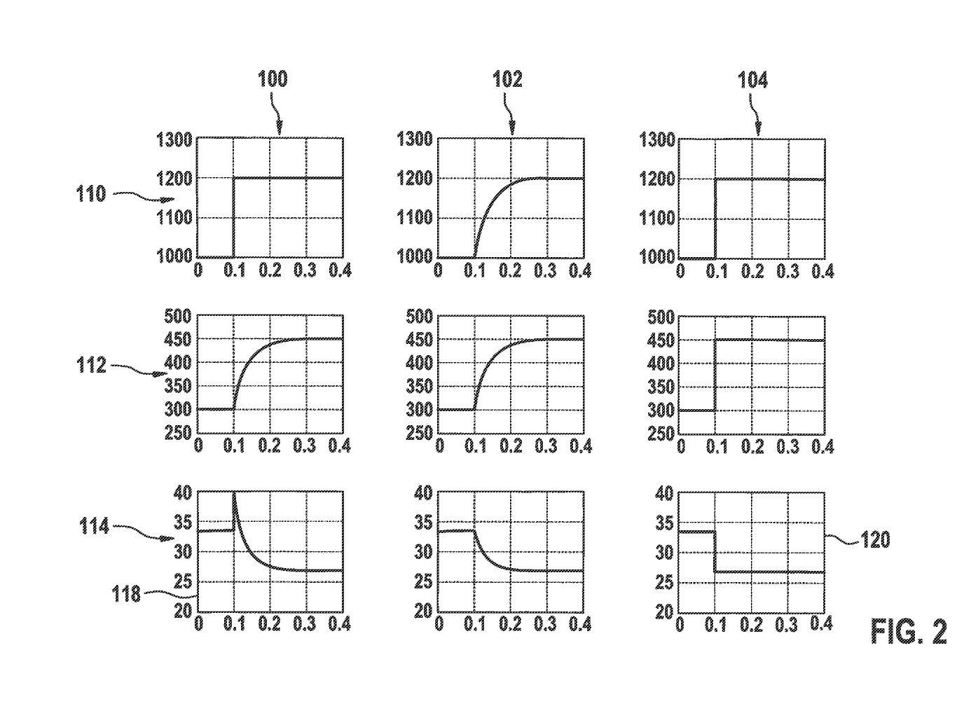

FIG. 2 shows, by way of example, the initial situation, the current solution according to the related art, and the ideal behavior of the physical measured signals, or rather the behavior achievable theoretically by the observer, which is achieved approximately by a method of the type presented.

The representation shows nine graphs in a matrix, characteristics of the initial situation being shown in a first column 100, characteristics according to the present procedure being shown in a second column 102, and characteristics according to an ideal behavior being shown in a third column 104. Characteristics of a fast signal S1 are represented in a first row 110, characteristics of a slow signal S2 are represented in a second row 112 and characteristics of a calculated value S3 are represented in a third row 114. In each case, the time is plotted on the abscissas of the graphs. A signal strength of fast signal S1 is plotted on the ordinates of the graphs of first row 110, a signal strength of slow signal S2 is plotted on the ordinates of the graphs of second row 112, and calculated value S3 is plotted on the ordinates of the graphs of third row 114, respectively.

FIG. 2 provides a representation of the phase position of the various signals S1, S2, S3. The following simple model equation is used for this:

S3=const*S1/S2 (1)

Due to the different phase position of changing signals S1 and S2, calculated value S3 has an overshoot, as can be seen in first column 100 in the graph at the bottom. This corresponds to the initial situation.

According to the current procedure in second column 102, faster signal S1 is adapted dynamically to slower signal S2. As a consequence, S3 has no overshoot, but is dynamically slower.

According to the ideal behavior in third column 104, signal S2 is adapted dynamically to S1. Calculated value S3 is dynamically faster and has no overshoot, as may be seen clearly in graph 120.

In order to adapt the slow signals to the fast signals, a system model is used, for example, which models the slow sensor values based on the inputs into the air system and the fast signals. With the inputs into the air system and the fast sensor signals, information is ready that early on may predict a change in the slow sensor signals. For a comparison of the modeled and measured values, it is necessary to adapt the fast modeled values dynamically to the slow sensor values.

In one specific embodiment of the method presented, by comparing the slow measured sensor values to the modeled slow sensor values, the system model may be corrected by a suitable weighting. This observer structure makes it possible to obtain both dynamically and steady-state accurate values.

The method introduced may be considered as a function that is stored, e.g., as software or a computer program in a control unit. This computer program, which includes program-code means for carrying out the method or for executing the function, is likewise subject matter of the present invention.

What is claimed is:

1. A method for processing sensor signals in a control unit of a motor vehicle, the control unit being provided for open-loop and/or closed-loop control of a system, the method comprising:
acquiring signals from the system, of which at least one signal is classified as slow signal and at least one signal is classified as fast signal;
ascertaining at least one value for the at least one slow signal based on a model of the system.

2. The method as recited in claim 1, wherein a time characteristic of the at least one slow signal is ascertained.

3. The method as recited in claim 1, wherein the system is modeled with a system model.

4. The method as recited in claim 1, wherein the system is modeled dynamically with at least one of the at least one fast signals and at least one input quantity into the system.

5. The method as recited in claim 1, further comprising:
adapting the model based on measured values in order to correct an observational error.

6. The method as recited in claim 1, further comprising:
at least one of controlling and regulating an exhaust gas recirculation in a combustion engine using the method.

7. The method as recited in claim 6, wherein the method is used in conjunction with a cylinder-charge control.

8. The method as recited in claim 1, wherein a controller signal is utilized as the fast signal.

9. The method as recited in claim 8, wherein a signal relating to at least one of a pressure-sensor value and a mass-flow value, is utilized as the slow signal.

10. A control unit for the open-loop and/or closed-loop control of a system, the control unit configured to acquire signals from the system, of which at least one signal is classified as slow signal and at least one signal is classified as fast signal, wherein the control unit is equipped to carry out a function in which the system is modeled with the aid of a model and at least one value is ascertained for the at least one slow signal based on the model.

11. The control unit as recited in claim 10, wherein the control unit is an engine control unit.

12. The control unit as recited in claim 10, wherein the function is implemented in a computer program that is stored in the control unit.
